(19) United States
(12) Patent Application Publication
(10) Pub. No.: US 2024/0326868 A1
(43) Pub. Date: Oct. 3, 2024

(54) SYSTEMS AND METHODS FOR ACTIVATING UNIFIED ARCHITECTURE COMPONENTS BASED ON VEHICLE MODE

(71) Applicant: Woven by Toyota, Inc., Tokyo (JP)

(72) Inventors: Vishnu R. Desaraju, Ann Arbor, MI (US); Sarah M. Koehler, San Jose, CA (US); Hiroshi Yasuda, San Francisco, CA (US); Michael L. Elkins, Farmingham, MA (US); Carrie Bobier-Tiu, Sunnyvale, CA (US); Selina Pan, Cupertino, CA (US)

(21) Appl. No.: 18/194,064

(22) Filed: Mar. 31, 2023

(51) Int. Cl. B60W 60/00; B60W 30/182; B60W 50/16

(52) U.S. Cl. CPC B60W 60/0015; B60W 30/182; B60W 50/16

(57) ABSTRACT

System, methods, and other embodiments described herein relate to managing a unified architecture for controlling a vehicle in multiple different modes. In one embodiment, a system includes a processor and a memory storing machine-readable instructions that, when executed by the processor, cause the processor to receive an instruction that identifies a target operating mode for a vehicle; determine whether the target operating mode is different from a current operating mode of the vehicle; identify components of a unified architecture of the vehicle to activate while in the target operating mode and operating parameters for the components to activate, the unified architecture to control the vehicle in a semi-autonomous mode and an autonomous mode; configure, based on the operating parameters, the components to activate while in the target operating mode; and activate the components according to the target operating mode.

### TECHNICAL FIELD

The subject matter described herein relates, in general, to systems and methods for controlling a vehicle that has an autonomous mode and a semi-autonomous mode, and, more particularly, to selectively activating and configuring different components of a unified architecture based on a target operating mode for the vehicle.

### BACKGROUND

Some vehicles operate in a semi-autonomous mode and an autonomous mode at different points in time. These vehicles include hardware components to assist and supplement driver commands while the vehicle is in a semi-autonomous mode and hardware components that completely control the driving of the vehicle without the need for any input from the driver while the vehicle is in an autonomous mode. A vehicle may have different architectures associated with each of the different modes. That is, the vehicle has a semi-autonomous architecture that includes the hardware components that are operative while the vehicle is in the semi-autonomous mode. A separate autonomous architecture includes hardware components that are active while the vehicle is in the autonomous mode. As such, vehicles that operate in multiple modes include multiple sets of hardware components. Each set may have hardware components that perform the same function. For example, a semi-autonomous architecture may have a controller and a planner. The autonomous architecture may also have a controller and a planner. In examples where the architectures share hardware components, there may be different algorithmic pipelines to control the hardware components. In this example, there may be separate modules in each pipeline. As with duplicate hardware components, these separate modules represent inefficient and duplicative components in the vehicle control system.

As such, present dual-mode vehicles include multiple and disparate architectures, each architecture controlling a single vehicle operating mode. This may lead to redundancy int the hardware components found in a vehicle as described above. Such redundancy increases the complexity of the vehicle's electrical and mechanical systems, increases the complexity of the control and management of the vehicle, introduces a greater likelihood of vehicle malfunction, and presents the user with a non-uniform interface.

### SUMMARY

In one embodiment, example systems and methods relate to a manner of managing a unified architecture for controlling a vehicle in multiple different modes. The unified architecture includes components that are active and used in both the autonomous and semi-autonomous modes, albeit in different configurations based on the target operating mode.

In one embodiment, a system for managing a unified architecture for controlling a vehicle in multiple different modes is disclosed. The system includes a processor and a memory storing machine-readable instructions. The instructions, when executed by the processor, cause the processor to receive an instruction that identifies a target operating mode of a vehicle and determine whether the target operating mode is different from a current operating mode of the vehicle. The instructions, when executed by the processor, cause the processor to identify components of a unified architecture of the vehicle to activate while in the target operating mode, including operating parameters for the components to activate. The unified architecture controls the vehicle in semi-autonomous and autonomous modes. The instructions, when executed by the processor, cause the processor to configure, based on the operating parameters, the components to activate while in the target operating mode and activate the components according to the target operating mode.

In one embodiment, a non-transitory computer-readable medium for managing a unified architecture for controlling a vehicle in multiple different modes and including instructions that, when executed by one or more processors, cause the one or more processors to perform one or more functions is disclosed. The instructions include instructions to receive an instruction that identifies a target operating mode for a vehicle and determine whether the target operating mode is different from a current operating mode of the vehicle. The instructions include instructions to identify components of a unified architecture of the vehicle to activate while in the target operating mode and operating parameters for the components to activate. The unified architecture is to control the vehicle in a semi-autonomous mode and an autonomous mode. The instructions include instructions to configure, based on the operating parameters, the components to activate while in the target operating mode and activate the components according to the target operating mode.

In one embodiment, a method for managing a unified architecture for controlling a vehicle in multiple different modes is disclosed. In one embodiment, the method includes the steps of receiving an instruction that identifies a target operating mode for a vehicle and determining whether the target operating mode is different from a current operating mode of the vehicle. The method also includes the step of identifying components of a unified architecture of the vehicle to activate while in the target operating mode and operating parameters for the components to activate. The unified architecture is to control the vehicle in a semi-autonomous mode and an autonomous mode. The method also includes the steps of configuring, based on the operating parameters, the components to activate while in the target operating mode and activating the components according to the target operating mode.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an architecture management system associated with managing a unified architecture for controlling a vehicle in multiple different modes.

FIG. 3 illustrates one embodiment of the unified architecture for controlling a vehicle while in a semi-autonomous mode.

FIG. 4 illustrates one embodiment of the unified architecture for controlling a vehicle while in an autonomous mode.

FIGS. 5A-5C illustrate one embodiment of the unified architecture for controlling a vehicle while in a semi-autonomous mode.

FIG. 6 illustrates one embodiment of the unified architecture for controlling a vehicle while in an autonomous mode.

FIG. 7 illustrates a flowchart associated with one embodiment of a method for managing a unified architecture for controlling a vehicle in multiple different modes.

### DETAILED DESCRIPTION

Systems, methods, and other embodiments associated with improving the management of a unified architecture for controlling a vehicle capable of operating in multiple different modes are disclosed herein. As described above, some vehicles operate in a semi-autonomous mode and an autonomous mode at different points in time. However, vehicles capable of dual-mode operation generally include separate architectures for each different operating mode. For example, a vehicle may have a first hardware architecture with specific hardware components for performing semi-autonomous operations such as advanced driver assistance (ADAS) operations. This same vehicle may have a second and different hardware architecture with different hardware components for performing autonomous operations. As such, present dual-mode vehicles include multiple and disparate architectures, each architecture controlling a single vehicle operating mode. This multi-architecture configuration leads to component redundancy, increased hardware complexity, increased complexity of controlling the vehicle, control inefficiencies, and a non-uniform driver interface. For example, each architecture may have a planner which estimates a latent world state. Accordingly, a planner of a semi-autonomous architecture provides this estimation while the vehicle is in a semi-autonomous mode. An autonomous architecture includes a separate planner that provides the same estimation while the vehicle is in the autonomous mode. As such, in existing vehicles, there are two components that output the same information. This is just one example, and other examples abound where a multi-architecture system for implementing dual-mode vehicle operations is inefficient, complex, costly, and ineffective. In an example, the separate architectures may share hardware components. However, there may be different algorithmic pipelines to control the hardware components. As such, there may be separate modules in each pipeline. As with duplicate hardware components, these separate modules represent inefficient and duplicative components in the vehicle control system.

Accordingly, the present specification describes a unified architecture, and the control and management thereof, that includes a component set used in both an autonomous mode and a semi-autonomous mode. That is, rather than having multiple architectures, a vehicle of the present specification has a single unified architecture to control the vehicle in both the autonomous and semi-autonomous modes. The components that are active vary based on the target operating mode of the vehicle. For example, a planner, a controller, and a platform driver of the unified architecture are active in both the semi-autonomous and autonomous modes. By comparison, other components of the unified architecture are not active in both operating modes. For example, a driver-state system, a reactive pipeline, a semi-autonomous manager, a human-machine interface (HMI) manager, and a haptic controller are active when the target operating mode is a semi-autonomous mode and not active when the target operating mode is the autonomous mode.

Moreover, when operating in the different modes, the active components of the unified architecture are configured differently and operate differently. For example, the planner of the unified architecture plans a trajectory for the vehicle. While in the semi-autonomous mode, an architecture management system configures the planner to output a trajectory with a safety boundary. By comparison, the architecture management system configures the same planner differently in the autonomous mode, specifically to output a trajectory without the safety boundary or with a safety boundary that is configured differently than the safety boundary generated when the vehicle is in the semi-autonomous mode. Thus, the architecture management system configures the parameters of the planner differently to cause the planner to operate distinctly for different modes. In various approaches, this involves configuring particular algorithms with different parameters that define limits for the algorithm and how the algorithm processes input data differently, such as different weights, control variables, and so on.

As another example, in the semi-autonomous mode, the architecture management system configures a controller of the unified architecture to receive a driver input command from a user input device (e.g., a steering wheel) and convert that driver input command into a vehicle command to turn the wheels of the vehicle. By comparison, while in the autonomous mode, the architecture management system configures the same controller to receive an automated driving command from a planner and convert the automated driving command from the planner into the vehicle command. Thus, the architecture management system configures the parameters of the controller differently to cause the controller to operate in a distinct manner for different modes. In various approaches, this involves configuring particular algorithms with different parameters that define limits for the algorithm and the way in which the algorithm processes input data differently, such as different weights, control variables, and so on.

As such, the present specification describes an architecture management system that selectively activates the different components of a unified architecture based on a target operating mode for the vehicle and a current operating mode of the vehicle. For those components of the unified architecture that are active in both the semi-autonomous mode and the autonomous mode, the architecture management system configures these components based on the target operating mode, with the configuration of the components being different between operating modes.

The unified architecture and architecture management system of the present specification improve the efficiency of vehicle control systems by removing redundant components and configuring particular components to operate within the paradigm of a selected target operating mode for the vehicle. The unified architecture also presents a driver with a unified user experience and utilizes the vehicle's full capabilities to prevent accidents and ensure safe driving.

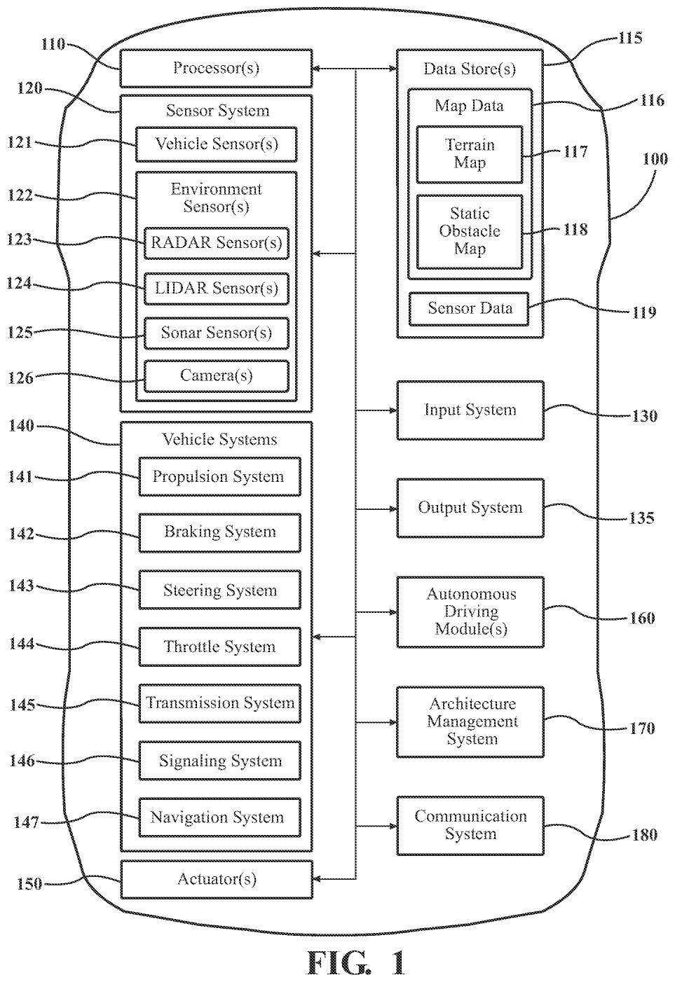

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any robotic device or form of motorized transport that, for example, includes multiple operating modes with differing levels of autonomy and user input, and thus benefits from the functionality discussed herein associated with controlling the semi-autonomous or autonomous operation of a vehicle via a unified architecture.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

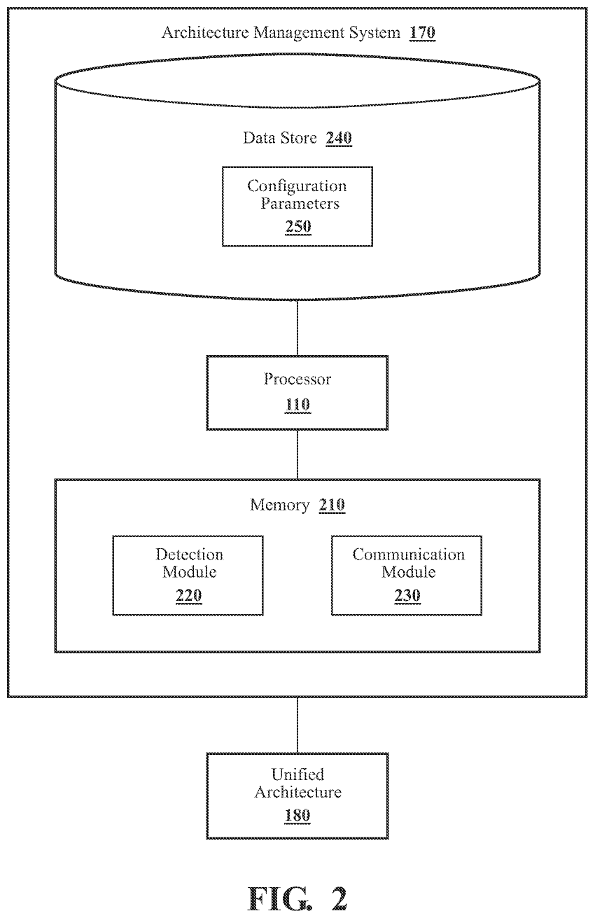

Some of the possible elements of the vehicle 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an architecture management system 170 that is implemented to perform methods and other functions as disclosed herein relating to improving the management of a unified architecture for controlling a vehicle capable of operating in multiple different modes.

With reference to FIG. 2, one embodiment of the architecture management system 170 of FIG. 1 is further illustrated. The architecture management system 170 is shown as including a processor 110 from the vehicle 100 of FIG. 1. Accordingly, the processor 110 may be a part of the architecture management system 170, the architecture management system 170 may include a separate processor from the processor 110 of the vehicle 100, or the architecture management system 170 may access the processor 110 through a data bus or another communication path. In one embodiment, the architecture management system 170 includes a memory 210 that stores a detection module 220 and a communication module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions that when executed by the processor 110 cause the processor 110 to perform the various functions disclosed herein. In further approaches, the modules 220 and 230 are hardware-based components, such as electronic controllers, logic circuits, and so on.

With reference to FIG. 2, the detection module 220 generally includes instructions that function to control the processor 110 to receive data inputs from one or more sensors of the vehicle 100. The inputs are, in one embodiment, observations of one or more objects in an environment proximate to the vehicle 100 and/or other aspects about the surroundings. As provided for herein, the detection module 220, in one embodiment, acquires configuration parameters 250, which define how the hardware components of the unified architecture 180 are to be configured.

That is, the configuration parameters 250 cause the hardware components of the unified architecture 180 to operate in a distinct manner based on the target operating mode for the vehicle 100. As described above, the configuration parameters 250 may include different parameters that define limits for an algorithm and the way in which the algorithm processes input data differently, such as different weights, control variables, and so on. Specific examples of target operating mode-specific configuration parameters 250, and how the different configuration parameters 250 cause the unified architecture 180 components to operate differently are described in further detail below.

In one approach, the configuration parameters 250 are indexed by hardware component and/or target operating mode. As has been discussed above and as will be discussed in greater detail below, different hardware components of the unified architecture 180 operate differently based on the target operating mode. Based on the configuration parameters 250 in the data store 240, the architecture management system 170 configures the abovementioned hardware components to operate differently.

Moreover, in one embodiment, the architecture management system 170 includes the data store 240. The data store 240 is, in one embodiment, an electronic data structure stored in the memory 210 or another data store and that is configured with routines that can be executed by the processor 110 for analyzing the configuration parameters 250 and other stored data, providing the configuration parameters 250 and other stored data, organizing the configuration parameters 250 and other stored data, and so on. Thus, in one embodiment, the data store 240 stores data used by the modules 220 and 230 in executing various functions. In one embodiment, the data store 240 includes the configuration parameters 250 along with, for example, metadata that characterizes various aspects of the configuration parameters 250. For example, the metadata can include indices by which the configuration parameters 250 are associated with particular hardware components and target operating modes, and so on.

The detection module 220, in one embodiment, is further configured to perform additional tasks beyond acquiring and providing the configuration parameters 250. For example, the detection module 220 1) selectively activates components of the unified architecture 180 based on the target operating mode being different from a current operating mode for the vehicle 100 and 2) configures the active components based on the target operating mode. As such, the detection module 220 includes instructions that cause the processor 110 to manage the unified architecture 180 and selectively activate components thereof based on the particular target operating mode for the vehicle 100.

Specifically, in at least one approach, the detection module 220 receives an instruction that identifies a target operating mode for the vehicle 100. As described above, the target operating mode may be 1) a semi-autonomous mode where driver inputs are supplemented by automated commands or 2) an autonomous mode where the autonomous driving module 160 controls the vehicle 100 without reliance on user inputs to steer, accelerate, and decelerate or otherwise control the movement of the vehicle 100.

Based on this instruction, the detection module 220 determines whether the target operating mode differs from the current operating mode for the vehicle 100. For example, it may be the case that the vehicle 100 is in an autonomous mode that does not rely on driver input, and a driver intends to switch the vehicle 100 to a semi-autonomous mode where a driver input controls, at least partially, the vehicle 100. When the target operating mode, for example, differs from the current operating mode, the detection module 220 identifies those components of the unified architecture 180 to be activated while in the target operating mode. Alternatively, the detection module 220 may identify the components upon initializing the vehicle 100 from an off-state.

Identifying whether the target operating mode differs from the current one may be made in several ways. For example, the data store 240 may include a register that identifies the current operating mode of the vehicle 100. In another example, the register may indicate the status of each hardware component of the unified architecture 180. In this example, the combination of active hardware components of the unified architecture 180 indicates the current operating mode of the vehicle 100.

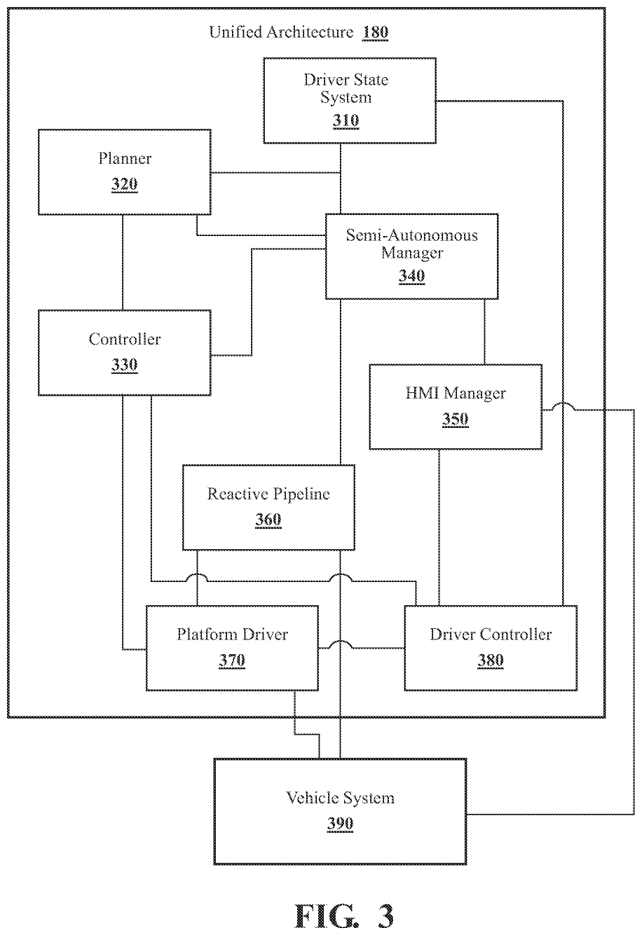

Upon determining the target operating mode for the vehicle 100 and whether such is different from a current operating mode for the vehicle 100, the detection module 220 determines which components of the unified architecture 180 will be active during the target operating mode. Specifically, the detection module 220 identifies, when the target operating mode is the autonomous mode, 1) a first subset of available components of the unified architecture 180 as the components that are to be active and 2) a second subset of available components of the unified architecture 180 as components that are to be inactive. A specific example of hardware components that are active or inactive based on the target operating modes is presented below in connection with FIGS. 3-6.

In one approach, the determination of which hardware components are to be active for a given target operating mode is based on the configuration parameters 250 in the data store 240. As described above, the configuration parameters 250 indicate which hardware components of the unified architecture 180 are to be selectively activated and how those selectively activated components are to be configured such that they operate differently based on the particular operating mode. Accordingly, the detection module 220 identifies the target operating mode and extracts, from the configuration parameters 250, an indication of which hardware components will be active for the given target operating mode.

The detection module 220 also determines how to configure the components that will be active for the given target operating mode. As described above, some components of the unified architecture 180 are active both during the autonomous mode and during the semi-autonomous mode. However, these components are configured differently based on the target operating mode.

For example, a planner of the unified architecture 180 has different configuration parameters 250 such that the output of the planner is unique to a particular operating mode. Specifically, the configuration parameters 250 of the planner in the semi-autonomous mode are such that the output of the planner is a trajectory with a safety boundary. The safety boundary refers to a lateral zone around the trajectory within which the vehicle 100 may laterally move without presenting a hazard to the driver, vehicle 100, or the surrounding environment. As such, in addition to generating a path that the vehicle 100 is to follow, the planner outputs a lateral safety boundary along the planned trajectory for the vehicle 100. So long as the vehicle sensors indicate that the vehicle 100 is within this safety boundary, the driver input commands are respected. However, if the driver issues a command that would place the vehicle 100 outside the safety boundary, the autonomous driving module 160 of the unified architecture 180 may supersede the driver input command. As such, when operating in the semi-autonomous mode, the planner outputs not only a target trajectory for the vehicle 100 but also a control signal indicating to the autonomous driving module 160 when autonomous vehicle commands should overtake any driver input.

In one arrangement, the detection module 220 configures parameters of a planning algorithm to receive information from various sensors of the vehicle 100 and to generate a safety boundary based on the received sensor information. As a particular example, the detection module 220 configures the planner to receive output from vehicle sensors such as external cameras, which capture images of the surrounding environment and identify, in those images, obstacles such as pedestrians, other vehicles, or lane markings. The detection module 220 configures the planning algorithm to receive this sensor output to determine lateral regions around the trajectory where no obstacle is located and identifies such as the safety boundary.

The detection module 220 also configures the planning algorithm to weight received input commands differently based on the position of the vehicle 100 relative to the safety boundary and/or the deviation of the vehicle 100 from the trajectory. That is, the detection module 220 configures the planner to weight an automated vehicle command more heavily as the vehicle 100 moves away from the trajectory towards the periphery of the safety boundary.

By comparison, the configuration parameters 250 of the planner in the autonomous mode are such that the output is a trajectory without a safety boundary or with a safety boundary that is configured differently than the safety boundary generated when the vehicle is in the semi-autonomous mode. In an autonomous mode, such a safety boundary may not be necessary as the vehicle 100, being automatedly controlled, does not deviate from the trajectory. As such, the architecture management system 170 configures the planner differently based on the selected target operating mode. Specifically, the detection module 220 configures the planner to have different parameters, e.g., processing operations to generate different outputs, which result in different functions of the unified architecture 180. As such, the detection module 220 configures the planner to disregard or block specific sensor output.

In one arrangement, the detection module 220 configures the planner to receive the sensor output but ignores such to create a safety boundary or processes the sensor output differently to generate a different safety boundary when is created when the vehicle is in the semi-autonomous mode. For example, when the vehicle is in a semi-autonomous mode, the safety boundary may be larger than a safety boundary when the vehicle is in an autonomous mode. As a specific example, the safety boundary for a vehicle in a semi-autonomous mode may include multiple lanes. The actual width of the safety boundary in the semi-autonomous mode may vary depending on the sensing capabilities and the map.

By comparison, when the vehicle is in the autonomous mode, a smaller fixed safety boundary is generated. As a specific example, the safety boundary in the autonomous mode may have a width of about one lane. As another example, the safety boundary in the autonomous mode may be 0.5 meters to either side of the trajectory. While particular reference is made to a particular safety boundary widths, other widths may be implemented in accordance with the principles described herein to allow for some deviation from the trajectory while ensuring a safety of the passengers and vehicle.

That is, the detection module 220 configures the planner to not generate the safety boundary. As such, the weights used by the planner to blend user input and automated input are adjusted as the planner need not blend user input with automated input in the autonomous mode as user input is not received in the autonomous mode.

As another example, the architecture management system 170 configures a controller of the unified architecture 180 differently based on the target operating mode. In general, the controller generates the control signals which manipulate the vehicle 100. In the different operating modes, the controller receives different inputs. As such, the conversion of the different input commands to vehicle commands differs between operating modes. Specifically, in the semi-autonomous mode, the controller may receive and blend user input commands and autonomous.

In contrast, the controller does not receive user input commands in the autonomous mode. Accordingly, the architecture management system 170 configures the parameters of the controller to blend and convert user input commands and automated driving commands to vehicle commands while in the semi-autonomous mode. Thus, the detection module 220 configures the controller with parameters to provide a defined amount of weight to the driver commands depending on a predicted trajectory associated with the commands. By comparison, in the autonomous mode, the architecture management system 170 configures the controller with parameters to provide automated driving commands depending on a predicted trajectory associated with the commands.

Accordingly, the detection module 220 includes instructions that control the processor 110 to generate, in response to an input, at least one control signal for controlling the vehicle 100 by an architecture management system 170. This is advantageous because the vehicle 100 does not require two or more architectures and overlapping components. Instead, the system implements a reconfigurable unified architecture 180 that can be used in either the semi-autonomous or autonomous mode by selectively activating specific components and re-configuring those components based on the target operating mode.

As such, the unified architecture 180 is utilized whether the vehicle 100 is in an autonomous mode or a semi-autonomous mode. The outputs from the detection module 220 are then provided to the communication module 230, which passes these signals onto the unified architecture 180. As stated above, many vehicles utilize two or more architectures that generate control signals. The unified architecture 180 and control thereof does not require two or more architectures or overlapping hardware.

FIG. 3 illustrates one embodiment of the unified architecture 180 for controlling a vehicle 100 while in a semi-autonomous mode. Note that in the semi-autonomous mode, all components of the unified architecture 180 are active as compared to the autonomous mode, where certain of the components of the unified architecture 180 are inactive.

Consideration will now be given to the various components of the unified architecture 180. The unified architecture 180 includes a planner 320 which generates a trajectory for the vehicle 100. As described above, the architecture management system 170 configures the planner 320, in the semi-autonomous mode, to output 1) the trajectory for the vehicle 100 and 2) a lateral safety boundary surrounding the trajectory. The architecture management system 170 may further configure the planner 320 to provide control signals to the HMI manager 350 regarding user interaction information. That is, along with the designation of the safety boundary, the architecture management system 170 configures the planner 320 to generate a control signal which, when received by the HMI manager 350, generates haptic feedback to indicate to the user when the vehicle 100 passes beyond the safety boundary. When operating in the autonomous mode, the planner 320 is configured to not output this haptic feedback control signal.

The controller 330 of the unified architecture 180 includes two components that control interactions with the vehicle 100. The first is the model predictive control (MPC) controller which generates steering and acceleration commands that drive the vehicle 100. The architecture management system 170 configures the controller 330 to, while in the semi-autonomous mode, as depicted in FIG. 3, generate a vehicle command that follows the driver input, but that can modify the driver input to keep the vehicle 100 within the safety boundary. The controller 330 also includes a haptic controller that determines the haptic feedback to be given to the driver based on the commands issued by both the driver and the MPC controller.

The driver state system 310 estimates the state, intent, and awareness of the driver. The driver state system 310 may include any number of sensors, including cameras, biological sensors, etc. The output of the driver state system 310 is provided to the HMI manager 350 to help guide the inform/warn notifications passed to the driver.

The semi-autonomous manager 340 includes components that govern semi-autonomous specific functionality, including system configurations. Specifically, the semi-autonomous manager 340 handles configuration options for semi-autonomous vehicle control, including enabling or disabling different features based on driver selection. The semi-autonomous manager 340 also assesses whether the unified architecture 180 satisfies the operational design domain (ODD) requirements to enable the semi-autonomous features. The semi-autonomous manager 340 combines the ODD assessment with user-specific configuration options to determine the overall semi-autonomous configuration and provides this information to the other components of the unified architecture 180.

The semi-autonomous manager 340 is a common interface to the human-machine interface (HMI) components. Specifically, the semi-autonomous manager 340 ingests planner 320, controller 330, and driver state system 310 output and synthesizes a set of risks that the HMI components can use to inform/warn the driver as needed.

The HMI manager 350 receives the output from the semi-autonomous manager 340 (i.e., the synthesized risk). Based on such, the HMI manager 350 configures the haptic feedback and generates the audiovisual cues for the driver.

The driver controller 380 of the unified architecture 180 is a unified hub for the driver input and haptic feedback devices. The driver controller 380 combines the haptic actuation requests and translates the result to the appropriate command format for the given interface device. The driver controller 380 also receives feedback on the state of the interface device and relays that state to other components of the unified architecture 180. This feedback is received from the platform driver 370 or directly via the interface libraries of other devices.

The reactive pipeline 360 is a dedicated, low-latency component that provides the last line of defense in safety-critical scenarios. The reactive pipeline 360 includes a low-latency perception stack that provides the basic situational awareness for low-latency interventions. As such, the inputs to the reactive pipeline 360 come directly from the sensors rather than the full perception stack used by the rest of the unified architecture 180. A low-latency action stack of the reactive pipeline 360 includes a reactive planner and a reactive controller.

The reactive commands output by the reactive controller are transmitted directly to the platform driver 370, which prioritizes these reactive commands over the output of the controller 330. The reactive commands are also transmitted to the semi-autonomous manager 340 to enable the main HMI components to maximize the driver's awareness and understanding of the environment.

A low-latency minimal HMI driver of the reactive pipeline 360 quickly and reliably communicates to the driver any actions that the reactive pipeline 360 may take. As such, the output of the reactive pipeline 360 does not pass through the HMI pipeline used by the rest of the unified architecture 180. Instead, the reactive pipeline 360 drives a simple set of robust HMI devices, such as a mono speaker and LEDs in the vehicle system 390.

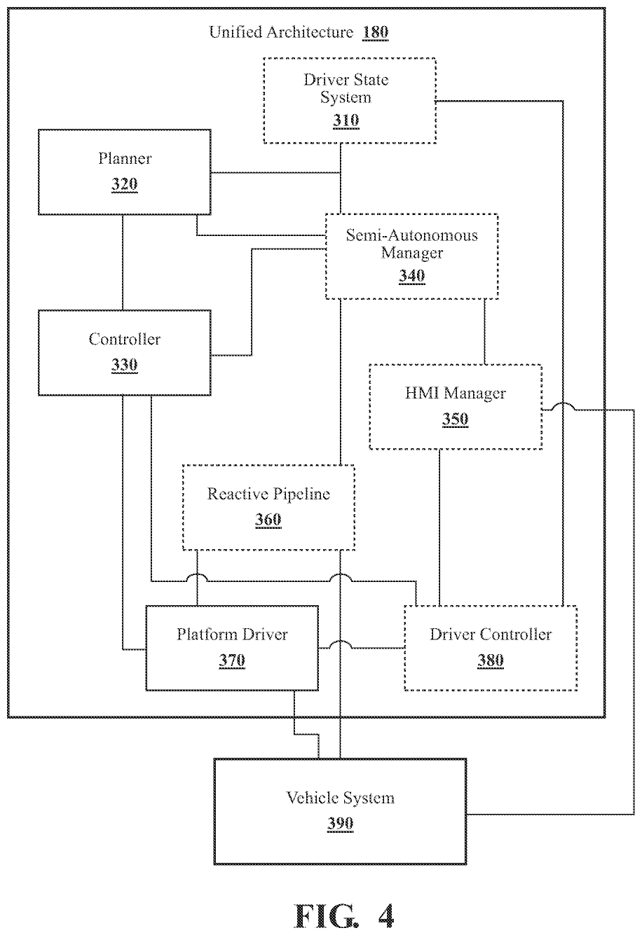

As described above, the architecture management system 170 identifies which components are to be active for a selected target operating mode and how active components are to be configured based upon a selected target operating mode. For example, when the target operating mode is the semi-autonomous mode, the driver state system 310, the reactive pipeline 360, the semi-autonomous manager 340, the HMI manager 350, the driver controller 380, the platform driver 370, the planner 320, and the controller 330 are identified as the components to activate as depicted in FIG. 3. As depicted in FIG. 4, a subset of these components of the unified architecture 180 are identified as components of the unified architecture 180 to activate when the target operating mode is the autonomous mode.

As described above, the components that are active in both modes, i.e., the planner 320, the platform driver 370, and the controller 330, are configured differently based on the target operating mode. In the semi-autonomous mode depicted in FIG. 3, the vehicle command may primarily be based on user input from a user input device such as a steering wheel, an accelerator pedal, and/or a brake pedal. Accordingly, the architecture management system 170 configures the controller 330 to receive these inputs, while blocking other types of input, such as automated driving commands, and converts the user input into a vehicle command executable by a platform driver 370 to move the vehicle 100 as intended by the driver input commands.

The architecture management system 170 also configures the planner 320 in a particular fashion based on the target operating mode being the semi-autonomous mode as depicted in FIG. 3. In this example, the architecture management system 170 configures the planner 320 to output a trajectory with a safety boundary as described above. In the semi-autonomous mode, a driver may have partial control over the vehicle 100 and may direct the vehicle to deviate, albeit to a small degree, away from the planned trajectory, for example to avoid a road obstacle. However, it may be the case that a driver input deviation may endanger the driver, the vehicle 100, or the surrounding environment. Accordingly, the architecture management system 170 configures the planner 320 to output an additional parameter that indicates a lateral region extending away from the trajectory where the vehicle 100 may safely travel without posing a threat to the driver, the vehicle 100, or the surrounding environment. As such, the architecture management system 170 configures the planner 320 to output not only the trajectory, but the safety boundary which serves as a trigger for supplanting a driver input command with an automated driving command.

As such, the architecture management system 170 configures parameters of the planner 320 differently in order to cause the planner 320 to operate in a distinct manner for different modes. In various approaches, this involves configuring particular algorithms with different parameters that define limits for the algorithm and the way in which the algorithm processes input data differently, such as different weights, control variables, and so on.

FIG. 4 illustrates one embodiment of the unified architecture 180 for controlling a vehicle 100 while in an autonomous mode. As described above, the unified architecture 180 includes a set of components that are selectively activated based on a target operating mode. When the target operating mode is the autonomous mode, the architecture management system 170 identifies the platform driver 370, the planner 320, and the controller 330 as the components of the unified architecture 180 that are to be active. The architecture management system 170 identifies the driver-state system 310, the reactive pipeline 360, the semi-autonomous manager 340, and the human-machine interface (HMI) manager 350 as components of the unified architecture to be inactive. In FIG. 4, those components that are inactive are identified in dashed lines. As such, FIGS. 3 and 4 clearly depict that the same unified architecture 180 has a different configuration per target operating mode wherein the architecture management system 170 selectively activates different components based on a selected target operating mode.

As described above, the architecture management system 170 configures the components that are active in both modes, i.e., the planner 320, the platform driver 370, and the controller 330 differently based on the target operating mode. For example, the controller 330 of the unified architecture 180 generates a vehicle command. When the target operating mode is the autonomous mode as depicted in FIG. 4, the architecture management system 170 configures the controller 330 to receive an automated driving command from a planner 320 and convert the automated driving command into the vehicle command. As the automated driving command is different from the driver command, the architecture management system 170 configures the controller 330 differently, so as to handle the format of the automated driving command and convert such into a vehicle command executable by a platform driver 370 to move the vehicle 100.

As such, the architecture management system 170 configures parameters of the controller 330 differently in order to cause the controller 330 to operate in a distinct manner for different modes. In various approaches, this involves configuring particular algorithms with different parameters that define limits for the algorithm and the way in which the algorithm processes input data differently, such as different weights, control variables, and so on.

As another example, the architecture management system 170 configures the planner 320 based on the target operating mode being the autonomous mode. In this example, the architecture management system 170 configures the planner 320 to output a trajectory without a safety boundary or with a safety boundary that is configured differently than the safety boundary generated when the vehicle is in the semi-autonomous mode. That is, when operating in an autonomous mode, where an automated vehicle command does not direct the vehicle 100 to deviate from a planned trajectory, it may not be necessary to output a safety boundary or it may be desirable to output a safety boundary with a different configuration than the safety boundary generated when the vehicle 100 is in the semi-autonomous mode.

As depicted in FIGS. 3 and 4, the unified architecture 180 stays the same even if the vehicle 100 changes modes between the autonomous mode and the semi-autonomous mode. Once a control signal has been generated, the transmission module 230 transmits the control signal to a vehicle system 390. The vehicle system 390 may be the autonomous driving module 160 that may control one or more of the vehicle systems 140. The control of the vehicle systems 140 may be via one or more actuators 150.

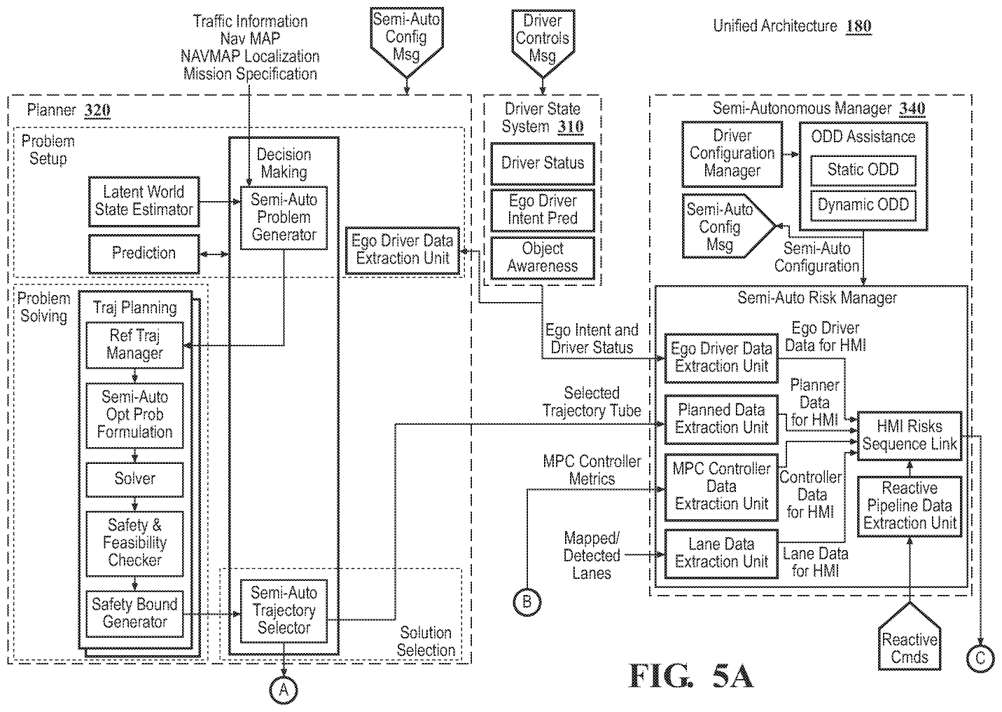

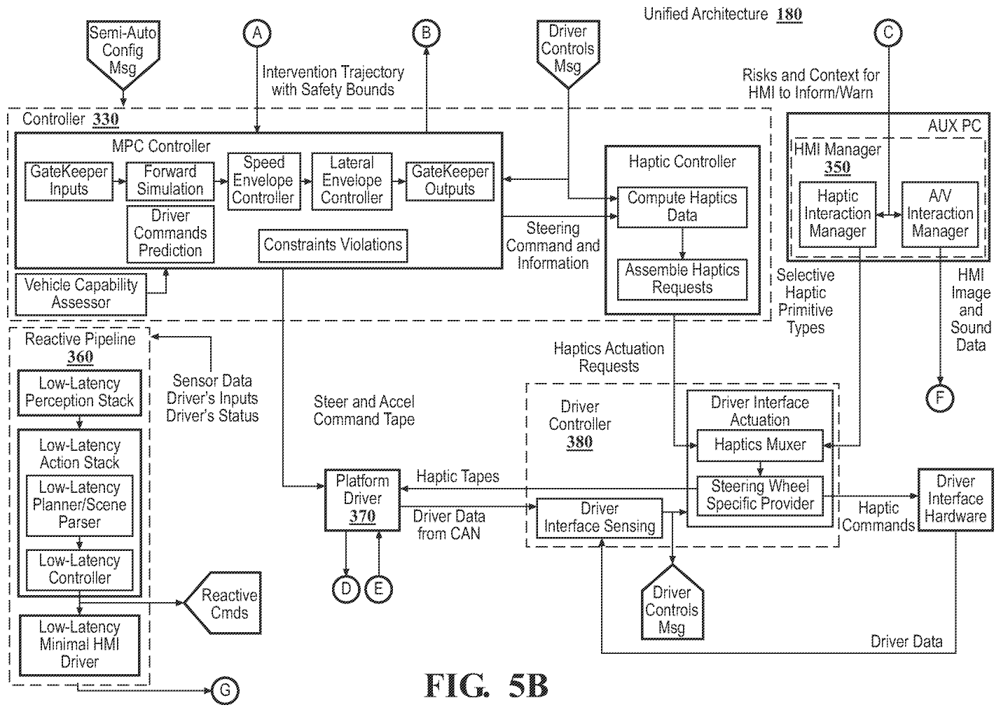

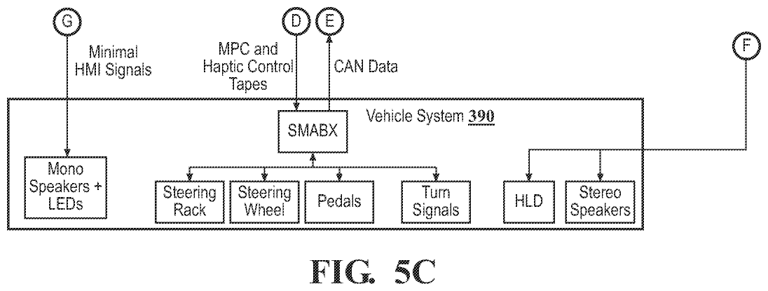

FIGS. 5A-5C illustrate one embodiment of the unified architecture 180 for controlling a vehicle 100 while in a semi-autonomous mode. Specifically, FIGS. 5A-5C depict the unified architecture 180 in more detail indicating sub-components of the components discussed above. As described above in connection with FIG. 3, in the semi-autonomous mode, each component of the unified architecture 180 is active, with certain components, e.g., the planner 320 and controller 330, being configured differently as when these components are active in the autonomous mode.

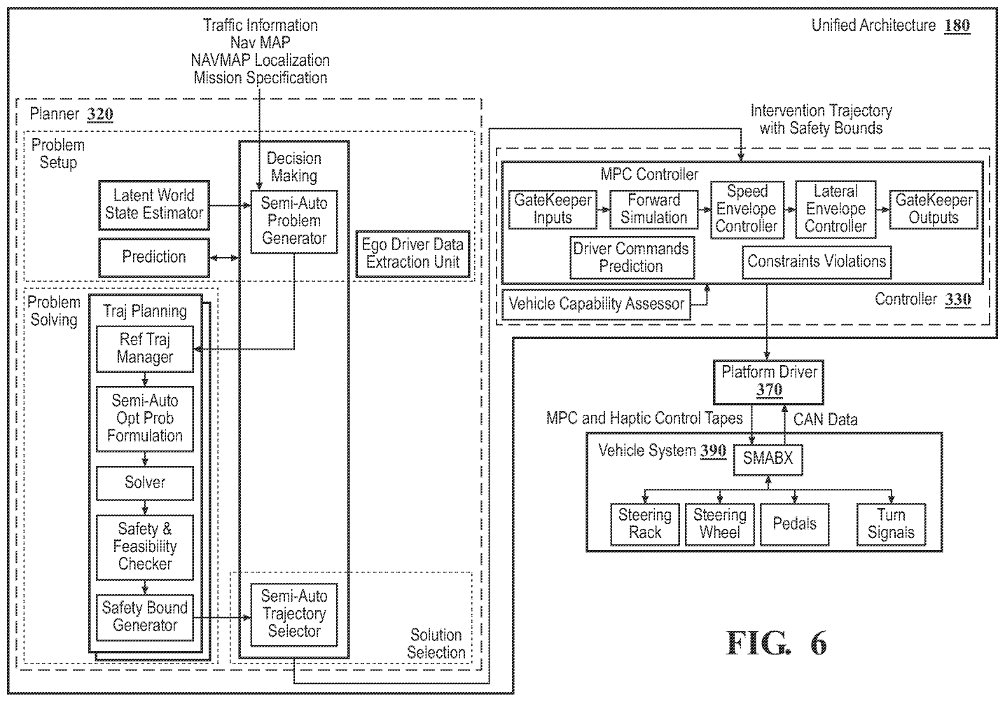

FIG. 6 illustrates one embodiment of the unified architecture 180 for controlling a vehicle 100 while in an autonomous mode. As with FIGS. 5A-5C, FIG. 6 depicts sub-components of those components previously discussed. Note that FIG. 6 depicts just those components that are active. As such, the driver state system 310, the semi-autonomous manager 340, the HMI manager 350, the reactive pipeline 360, and the driver controller 380 are not depicted in FIG. 6 as such are inactive.

FIGS. 5A-5C and 6 also depict an additional configurational change of the unified architecture 180 between the semi-autonomous mode and the autonomous mode. Specifically, as depicted in FIGS. 5A-5C and 6, the controller 330 includes a haptic controller which provides haptic feedback to the driver regarding input commands (e.g., steering, acceleration, and braking commands). When the target operating mode is the semi-autonomous mode as depicted in FIGS. 5A-5C, the architecture management system 170 activates the haptic controller to provide haptic feedback to the driver, for example to indicate when the driver input command draws the vehicle 100 outside the safety boundary. By comparison, when the target operating mode is the autonomous mode as depicted in FIG. 6, the architecture management system 170 de-activates the haptic controller as haptic feedback is not necessary due to the vehicle 100 being controlled without user input. As such, the architecture management system 170 configures the controller 330 differently in the autonomous mode, i.e., the haptic controller is inactive, as compared to the semi-autonomous mode where the haptic controller is active.

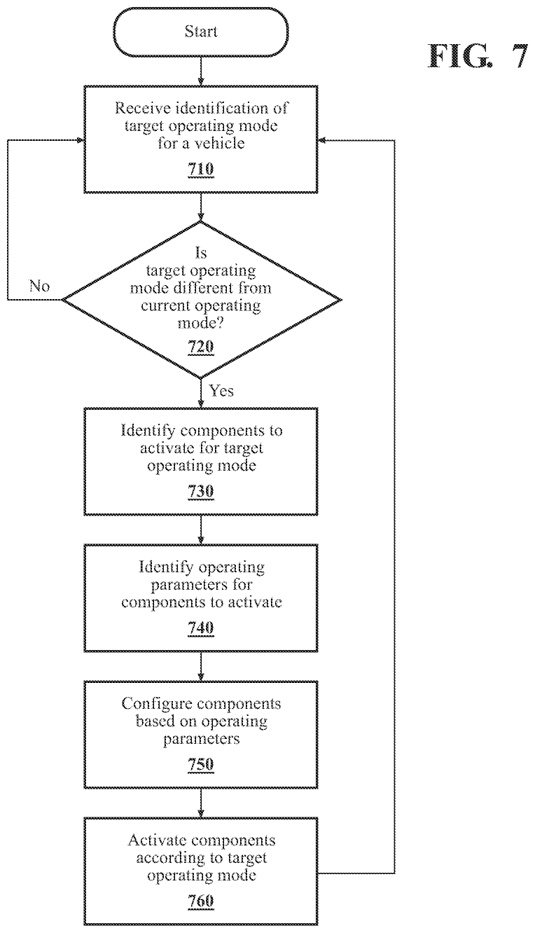

FIG. 7 illustrates a flowchart for managing a unified architecture 180 for controlling a vehicle 100 while in multiple different modes. Additional aspects of controlling a vehicle 100 in an autonomous or semi-autonomous mode will be discussed in relation to FIG. 7. FIG. 7 illustrates a flowchart of a method 700 that is associated with managing a unified architecture 180 for controlling a vehicle 100 in multiple different modes. Method 700 will be discussed from the perspective of the architecture management system 170 of FIGS. 1, and 2. While method 700 is discussed in combination with the architecture management system 170, it should be appreciated that the method 700 is not limited to being implemented within the architecture management system 170 but is instead one example of a system that may implement the method 700.

At 710, the architecture management system 170 receives an instruction that identifies a target operating mode for the vehicle 100. For example, a driver may, via a user interface element such as a button, touchscreen interface, etc., indicate a target operating mode for the vehicle 100. While particular reference is made to a driver selection of the target operating mode, the architecture management system 170 may determine the target operating mode for the vehicle 100 in other ways. For example, the architecture management system 170 may be able to monitor the sensor system 120 to determine if the vehicle 100 should be in an autonomous mode or a semi-autonomous mode. In either case, the architecture management system 170 then maps the identification of the target operating mode to a first subset of available components of the unified architecture 180 that are to be activated while the vehicle is in the target operating mode.

In an example, a controller of the architecture management system 170 determines the target operating mode while the vehicle is moving. That is, a switch between activating/deactivating certain components of the unified architecture 180 and the configuration of the active components may be made on-the-fly as the vehicle is driving along a path. In one approach, the switch between the activation/deactivation of certain components of the unified architecture 180 and the configuration of the active components may be made on system startup.

At 720, the architecture management system 170 determines whether the target operating mode is different from a current operating mode for the vehicle 100. This may be done in a variety of ways. For example, the data store 240 may include a register which identifies a current operating mode of the vehicle 100. In another example, the register may indicate the status of each hardware component of the unified architecture 180. In this example, the combination of active hardware components of the unified architecture 180 indicates the current operating mode of the vehicle 100. In one example, the detection module 220 may identify the components upon initializing the vehicle 100 from an off state.

If the target operating mode is the same as the current operating mode, the architecture management system 170 waits for a subsequent received identification of a target operating mode for the vehicle 100 to determine whether the subsequently received target operating mode is different than a current operating mode for the vehicle 100.

By comparison, if the current operating mode is different than a target operating mode, the architecture management system 170 may take appropriate action. Specifically, if the target operating mode is different than the current operating mode, the architecture management system 170, at 730, identifies those components that are to be activated based on the target operating mode. When the target operating mode is the semi-autonomous mode, the active components are the driver state system 310, the planner 320, the semi-autonomous manager 340, the controller 330, the reactive pipeline 360, the HMI manager 350, the platform driver 370, and the driver controller 380 as depicted in FIGS. 3 and 5A-5C. When the target operating mode is the autonomous mode, the active components are the planner 320, the controller 330, and the platform driver 370 as depicted in FIGS. 4 and 6.

At 740, the architecture management system 170 identifies configuration parameters 250 for the components to activate. For example, the architecture management system 170 determines the configuration parameters 250 for the planner 320 and the controller 330 based on the target operating mode. In one approach, the detection module 220 extracts the configuration parameters 250 from the data store 240. That is, the architecture management system 170 includes a data store 240 that holds configuration parameters 250 that define how the hardware components operate in different operating modes. Accordingly, the detection module 220 identifies the target operating mode and extracts the configuration parameters 250 from the data store 240. As described above, the configurations for the planner 320 and controller 330 are different between when the target operating mode is the semi-autonomous mode vs. the autonomous mode.

In addition to identifying the components to activate and operating parameters for such, the architecture management system 170 may also validate a switch between operating modes. Specifically, the architecture management system 170 may perform a validity check by determining that the components associated with the target operating mode are functioning and components not associated with the target operating mode are in an inactive mode. For example, each component in FIGS. 5A-5C and 6 may include a validity component that returns a signal indicating its status to the architecture management system 170. If any signal returned from a component that is to be active indicates the associated component is malfunctioning, the architecture management system 170 may prevent activation, or switching, of the operating mode of the vehicle 100. In addition to preventing a switch to an operating mode that would result in a malfunction of the unified architecture 180, the architecture management system 170 may provide a notification to the user of the error and resulting switch prevention. Following the validation, the architecture management system 170 authorizes activation of the components based on the validity check.

At 750, the architecture management system 170 configures the active components based on the operating parameters. That is, the architecture management system 170 configures particular algorithms with different parameters that define limits for the algorithm and the way in which the algorithm processes input data differently, such as different weights, control variables, conversion factors, and so on.

At 760, the architecture management system 170 activates the active components according to the target operating mode. Specifically, the detection module 220 transmits the parameters to the unified architecture 180 via the communication module 230 such that the hardware components implement the functionality defined by the associated configuration parameters 250.

As such, the unified architecture 180 and architecture management system 170 of the present specification improve the efficiency of vehicle control systems by removing redundant components and configuring particular components to operate within the paradigm of a selected target operating mode for the vehicle.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver).

In one or more embodiments, the vehicle 100 is an autonomous vehicle that is capable of operating in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the architecture management system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, the architecture management system 170, and/or the automated driving module(s) 160 may control some or all of these vehicle systems 140 and, thus, may be partially or fully autonomous.

The processor(s) 110, the architecture management system 170, and/or the automated driving module(s) 160 can be operatively connected to communicate with the various vehicle systems 140 and/or individual components thereof. For example, returning to FIG. 1, the processor(s) 110, the architecture management system 170, and/or the automated driving module(s) 160 can be in communication to send and/or receive information from the various vehicle systems 140 to control the movement, speed, maneuvering, heading, direction, etc. of the vehicle 100. The processor(s) 110, the architecture management system 170, and/or the automated driving module(s) 160 may control some or all of these vehicle systems 140.

The processor(s) 110, the architecture management system 170, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, the architecture management system 170, and/or the automated driving module(s) 160 can control the direction and/or speed of the vehicle 100. The processor(s) 110, the architecture management system 170, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110 and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the architecture management system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the configuration parameters 250. In general, the automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
receive an instruction that identifies a target operating mode of a vehicle;
determine whether the target operating mode is different from a current operating mode of the vehicle;
identify components of a unified architecture of the vehicle to activate while in the target operating mode and operating parameters for the components, the unified architecture controlling the vehicle in a semi-autonomous mode and an autonomous mode;
configure, based on the operating parameters, the components while in the target operating mode; and
activate the components according to the target operating mode.

2. The system of claim 1, wherein the instructions to identify components comprise instructions to identify, when the target operating mode is the autonomous mode:
a first subset of available components of the unified architecture as the components that are to be active; and
a second subset of available components of the unified architecture as components that are to be inactive.

3. The system of claim 1, wherein the instructions to identify components comprise instructions to identify, when the target operating mode is the semi-autonomous mode, a driver state system, a reactive pipeline, a semi-autonomous manager, a human-machine interface (HMI) manager, a driver controller, a platform driver, a planner, and a controller as the components of the unified architecture to activate, a subset of the components of the unified architecture also being identified when the target operating mode is the autonomous mode.

4. The system of claim 1, wherein the instructions to identify components comprise instructions to identify, when the target operating mode is the autonomous mode:
a platform driver, a planner, and a controller as the components of the unified architecture to be active; and
a driver-state system, a reactive pipeline, a semi-autonomous manager, a human-machine interface (HMI) manager, and a haptic controller of the controller as components of the unified architecture to be inactive.

5. The system of claim 1, further comprising instructions to plan, via a planner of the unified architecture, a trajectory for the vehicle, wherein the instructions to configure the components comprises instructions to configure the planner, when the target operating mode is the autonomous mode, to output the trajectory without a safety boundary.

6. The system of claim 5, further comprising instructions to plan, via a planner of the unified architecture, a trajectory for the vehicle, wherein the instructions to configure the components comprises instructions to configure the planner, when the target operating mode is the semi-autonomous mode, to output the trajectory with a safety boundary.

7. The system of claim 1, further comprising instructions to generate, via a controller of the unified architecture, a vehicle command, wherein:
the instructions to configure the components comprise instructions to configure the controller, when the target operating mode is the semi-autonomous mode, to receive a user input command from a user input device and convert the user input command into the vehicle command to be executed by a platform driver of the unified architecture; and
the instructions to configure the components comprises instructions to configure the controller, when the target operating mode is the autonomous mode, to receive an automated driving command from a planner of the unified architecture and convert the automated driving command to the vehicle command to be executed by the platform driver.

8. The system of claim 1, wherein the instructions to identify components of the unified architecture further comprise:
instructions to perform a validity check by determining that the components associated with the target operating mode are functioning and components not associated with the target operating mode are in an inactive mode; and
instructions to authorize activation of the components based on the validity check.

9. A non-transitory machine-readable medium comprising instructions that, when executed by a processor, cause the processor to:
receive an instruction that identifies a target operating mode for a vehicle;
determine whether the target operating mode is different from a current operating mode of the vehicle;
identify components of a unified architecture of the vehicle to activate while in the target operating mode and operating parameters for the components, the unified architecture controlling the vehicle in a semi-autonomous mode and an autonomous mode;
configure, based on the operating parameters, the components while in the target operating mode; and
activate the components according to the target operating mode.

10. The non-transitory machine-readable medium of claim 9, wherein the instructions to identify components comprise instructions to identify, when the target operating mode is the semi-autonomous mode, a driver state system, a reactive pipeline, a semi-autonomous manager, a human-machine interface (HMI) manager, a driver controller, a platform driver, a planner, and a controller as the components of the unified architecture to activate, a subset of the components of the unified architecture also being identified when the target operating mode is the autonomous mode.

11. The non-transitory machine-readable medium of claim 9, wherein the instructions to identify components comprise instructions to identify, when the target operating mode is the autonomous mode:
a platform driver, a planner, and a controller as the components of the unified architecture to be active; and
a driver-state system, a reactive pipeline, a semi-autonomous manager, a human-machine interface (HMI) manager, and a haptic controller of the controller as components of the unified architecture to be inactive.

12. A method, comprising:
receiving an instruction that identifies a target operating mode for a vehicle;
determining whether the target operating mode is different from a current operating mode of the vehicle;
identifying components of a unified architecture of the vehicle to activate while in the target operating mode and operating parameters for the components, the unified architecture controlling the vehicle in a semi-autonomous mode and an autonomous mode;
configuring, based on the operating parameters, the components while in the target operating mode; and
activating the components according to the target operating mode.

13. The method of claim 12, wherein identifying the components comprises identifying, when the target operating mode is the autonomous mode:
a first subset of available components of the unified architecture as the components that are to be active; and
a second subset of available components of the unified architecture as components that are to be inactive.

14. The method of claim 12, wherein identifying the components comprises identifying, when the target operating mode is the semi-autonomous mode, a driver state system, a reactive pipeline, a semi-autonomous manager, a human-machine interface (HMI) manager, a driver controller, a platform driver, a planner, and a controller as the components of the unified architecture to activate, a subset of the components of the unified architecture also being identified when the target operating mode is the autonomous mode.

15. The method of claim 12, wherein identifying the components comprises identifying, when the target operating mode is the autonomous mode:
a platform driver, a planner, and a controller as the components of the unified architecture to be active; and
a driver-state system, a reactive pipeline, a semi-autonomous manager, a human-machine interface (HMI) manager, and a haptic controller of the controller as components of the unified architecture to be inactive.

16. The method of claim 12, further comprising planning, via a planner of the unified architecture, a trajectory for the vehicle, wherein configuring the components comprises configuring the planner, when the target operating mode is the autonomous mode, to output the trajectory without a safety boundary.

17. The method of claim 12, further comprising planning, via a planner of the unified architecture, a trajectory for the vehicle, wherein configuring the components comprises configuring the planner, when the target operating mode is the semi-autonomous mode, to output the trajectory with a safety boundary.

18. The method of claim 12, further comprising generating, via a controller of the unified architecture, a vehicle command, wherein:
configuring the components comprises configuring the controller, when the target operating mode is the semi-autonomous mode, to receive a user input command from a user input device and convert the user input command into the vehicle command to be executed by a platform driver of the unified architecture; and
configuring the components comprises configuring the controller, when the target operating mode is the autonomous mode, to receive an automated driving command from a planner of the unified architecture and convert the automated driving command to the vehicle command to be executed by the platform driver.

19. The method of claim 12, wherein receiving an instruction comprises:
receiving, at a controller of the unified architecture, a user selection of the target operating mode while the vehicle is moving; and
mapping the user selection to a first subset of available components of the unified architecture to activate while in the target operating mode.

20. The method of claim 12, wherein identifying components of a unified architecture to activate further comprises:
performing a validity check by determining that the components associated with the target operating mode are functioning and components not associated with the target operating mode are in a deactivated mode; and
authorizing activation of the components based on the validity check.
